(19) United States
(12) Patent Application Publication
(10) Pub. No.: US 2026/0111809 A1
(43) Pub. Date: Apr. 23, 2026

(54) SYSTEM AND METHOD FOR ASYNCHRONOUSLY CLUSTERING WORK ITEMS

(71) Applicant: DevRev, Inc., Palo Alto, CA (US)

(72) Inventor: Dominik Damjakob, Austin, TX (US)

(73) Assignee: DevRev, Inc., Palo Alto, CA (US)

(21) Appl. No.: 18/919,905

(22) Filed: Oct. 18, 2024

(51) Int. Cl. G06Q 10/0631

(52) U.S. Cl. CPC G06Q 10/06311

(57) ABSTRACT

A clustering system for asynchronously clustering work items is provided. The clustering system comprises a user interface configured to enable a user to define a schedule. The clustering system further includes a clustering module communicatively coupled to the user interface and configured to retrieve a plurality of work items based on the schedule, retrieve a plurality of embeddings corresponding to the plurality of work items and asynchronously generate a first hierarchy of clusters by clustering embeddings based on the defined schedule.

### BACKGROUND

The invention generally relates to the field of data analysis and more particularly, to a system and method for asynchronously clustering work items.

Service centers, to deliver uninterrupted service towards achieving business efficiency, employ various systems to track customer feedback and/or requests. Ticketing systems is an example of one such system which is responsible for handling huge volumes of work items or tickets generated by large enterprise organizations.

When handling work items and associated conversations encapsulated in the work item, it is useful to be able to associate these tickets with specific topics. This enables a customer-support system to provide customers and product developers with comprehensive view of commonly occurring issues. This information about specific topics also facilitates improving the products and the service.

However, work items accumulated by an organization can be large in number, with counts often ranging in the tens of thousands of items. In order to view a specific set of work items, simple filtering may result in an output of hundreds or sometimes thousands of work items. It is often very challenging to review or even act on many work items in a timely and efficient manner.

Another challenge is the difficulty for users of the ticketing system to track schedule-based work items relevant to the customers, for example, product features commonly requested in the last 24 hours, or problems reported by customers in the last 3 days and the like. In such cases, it is important that work items provided to the customer support systems is specific to the schedule and optimal in number.

Another challenge is that customers want to prioritize commonly requested features or put a bigger focus on addressing regularly occurring problems. This is also important for their resource allocation. If a general new feature that requires a lot of work is often discussed in their tickets, the company will want to focus a larger development team on this and grant them sufficient time to develop the features. It is challenging to find both larger new topics and common problems since this requires explorative analysis.

Therefore, there is a need for a clustering system that can asynchronously cluster work items based on a schedule defined by the user while optimizing resources.

### SUMMARY

The following summary is illustrative only and is not intended to be in any way limiting. In addition to the illustrative aspects, example embodiments, and features described, further aspects, example embodiments, and features will become apparent by reference to the drawings and the following detailed description.

Briefly, according to an example embodiment, a clustering system for asynchronously clustering work items is provided. The clustering system comprises a user interface configured to enable a user to define a schedule. The clustering system further includes a clustering module communicatively coupled to the user interface and configured to retrieve a plurality of work items based on the schedule, retrieve a plurality of embeddings corresponding to the plurality of work items and asynchronously generate a first hierarchy of clusters by clustering embeddings based on the defined schedule.

In another embodiment, a method for asynchronously clustering a plurality of work items is provided. The method includes defining a schedule, retrieving a plurality of work items based on recurring schedule, retrieving a plurality of embeddings corresponding to the plurality of work items and asynchronously generating a first hierarchy of clusters by clustering embeddings based on the defined schedule.

### BRIEF DESCRIPTION OF THE FIGURES

These and other features, aspects, and advantages of the example embodiments will become better understood when the following detailed description is read with reference to the accompanying drawings in which like characters represent like parts throughout the drawings, wherein:

FIG. 1 is a block diagram of an embodiment of a clustering system for asynchronously clustering a plurality of work items, implemented according to aspects of the present technique;

FIG. 2 is a flow chart describing one method by hierarchical clusters are generated, implemented according to aspects of the present technique;

FIG. 3 and FIG. 4 are examples of a user interface implemented according to aspects of the present technique; and

FIG. 5 is a block diagram of an embodiment of a computing device in which the modules of the clustering system for clustering a plurality of work items described herein are implemented.

### DETAILED DESCRIPTION OF EXAMPLE EMBODIMENTS

Various example embodiments will now be described more fully with reference to the accompanying drawings in which only some example embodiments are shown. Specific structural and functional details disclosed herein are merely representative for purposes of describing example embodiments. Example embodiments, however, may be embodied in many alternate forms and should not be construed as limited to only the example embodiments set forth herein. On the contrary, example embodiments are to cover all modifications, equivalents, and alternatives thereof.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Before discussing example embodiments in more detail, it is noted that some example embodiments are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed but may also have additional steps not included in the figures. It should also be noted that in some alternative implementations, the functions/acts/steps noted may occur out of the order noted in the figures. For example, two figures shown in succession may, in fact, be executed substantially concurrently or may sometimes be executed in the reverse order, depending upon the functionality/acts involved.

Spatial and functional relationships between elements (for example, between modules) are described using various terms, including “connected,” “engaged,” “interfaced,” and “coupled.” Unless explicitly described as being “direct,” when a relationship between first and second elements is described in the description below, that relationship encompasses a direct relationship where no other intervening elements are present between the first and second elements, and also an indirect relationship where one or more intervening elements are present (either spatially or functionally) between the first and second elements. In contrast, when an element is referred to as being “directly” connected, engaged, interfaced, or coupled to another element, there are no intervening elements present. Other words used to describe the relationship between elements should be interpreted in a like fashion (e.g., “between,” versus “directly between,”“adjacent,”versus “directly adjacent,”etc.).

The terminology used herein is for the purpose of describing particular example embodiments only and is not intended to be limiting. Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Unless specifically stated otherwise, or as is apparent from the description, terms such as “processing” or “computing” or “calculating” or “determining” of “displaying” or the like, refer to the action and processes of a computer system, or similar electronic computing device/hardware, that manipulates and transforms data represented as physical, electronic quantities within the computer system's registers and memories into other data similarly represented as physical quantities within the computer system memories or registers or other such information storage, transmission or display devices.

Example embodiments of the present invention provide systems and methods for asynchronously clustering a plurality of work items. As used herein, a work item may include a ticket representing a customer request and/or problem, interactions between two entities such as a customer and a customer service representative, customer accounts, opportunities, contacts, invoices, knowledge base articles, frequently asked questions and related answers (like FAQs), platform users, customer workspaces and parts, developer work items, work items created for employees and the like.

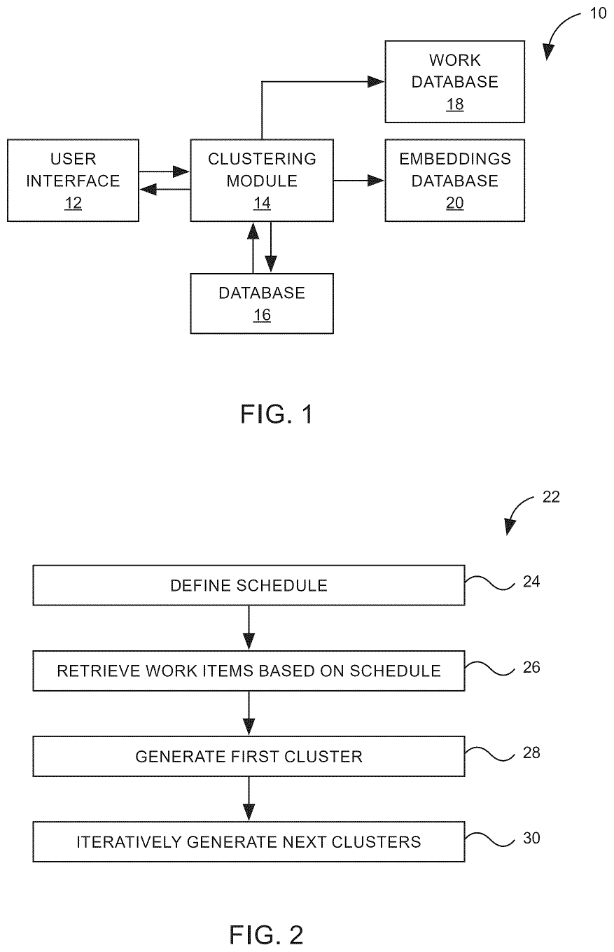

FIG. 1 is a block diagram of an embodiment of a clustering system implemented according to aspects of the present technique. The clustering system includes a user interface 12, clustering module 14, database 16, work database 18 and embedding database 20. Each component is described in further detail below.

User interface 12 is configured to enable a user to define a schedule for retrieving a plurality of work items. In one embodiment, the schedule is recurring at regular intervals of time and is defined by the user. Examples of the schedule include a time range, a date range, status, owner, and the like. In one embodiment, the user selects a specific schedule from a drop-down menu and/or a calendar. The user may also enter a specific schedule in a tab on the user interface.

Clustering module 14 is communicatively coupled to user interface 12 and is configured to retrieve a plurality of work items from work database 18 based on the schedule. Clustering module 14 is configured to apply a clustering model on embeddings of the plurality of work items and asynchronously generate a first hierarchy of clusters by clustering embeddings. The embeddings of the work items are retrieved from embeddings database 20.

Clustering module 14 is further configured to generate a second hierarchy of clusters from each cluster in the first hierarchy of clusters. In one embodiment, the second hierarchy of clusters is generated based on the schedule defined by the user. The number of work items in the second hierarchy of clusters is less than the number of work items in the first hierarchy of clusters. In general, the clustering module is configured to iteratively generate subsequent hierarchy of clusters where the number of work items in each subsequent hierarchy of clusters is less than the number of work items in a preceding hierarchy of clusters.

It may be noted that asynchronous clustering enables users to iteratively reduce the number of work items in each cluster. For example, users can generate asynchronous clusters for ticket work items for a specific date and time thus reducing the number of work items to be examined to an optimal number. Further, users may be enabled to also generate asynchronous clusters for work items created for a specific customer and for a specific time frame thereby reducing the number of items in the cluster, or for work items assigned to a specific part, or those with a specific tag, or any combination thereof.

Clustering model 14 is further configured to generate a title for each work group. In one embodiment, the work group title is based one or more recurring keywords in the work items of the cluster. The cluster titles may also summarize the underlying topic or direction of the work groups as indicated by their work titles.

Clustering module 14 is further configured to generate a summary for each work group. In one embodiment the summary includes a count of the number of work items, the average age of the work items, the count of work items attached to a feature part, the count of work items attached to an enhancement part and the like. The work group and the corresponding work group title, and the summary are displayed to the one or more users via the user interface.

Database 16 is coupled to the clustering module and is configured to store the first hierarchy of clusters, the second hierarchy of clusters and the subsequent hierarchy of clusters. Further, the database is configured to delete the previous first hierarchy of clusters, the second hierarchy of clusters and the subsequent hierarchy of clusters upon completion of a subsequent schedule.

User interface 12 is further configured to the user interface is configured to display, for each schedule, a snapshot of the first hierarchy of clusters, the second hierarchy of clusters and the subsequent hierarchy of clusters. User interface is also configured to enable the one or more users to interactively provide feedback for the work group generated by the clustering module. In one embodiment, the user provides feedback in the form of a thumbs-up/thumbs-down button. The feedback is used by the clustering model 14 to evaluate an accuracy of the clusters. Database 16 is configured to receive and store the feedback provided by the one or more users.

As described herein, the clustering system is configured to asynchronously cluster a plurality of work items to generate multiple hierarchy of clusters. The manner in which the clusters are generated is described in further detail below.

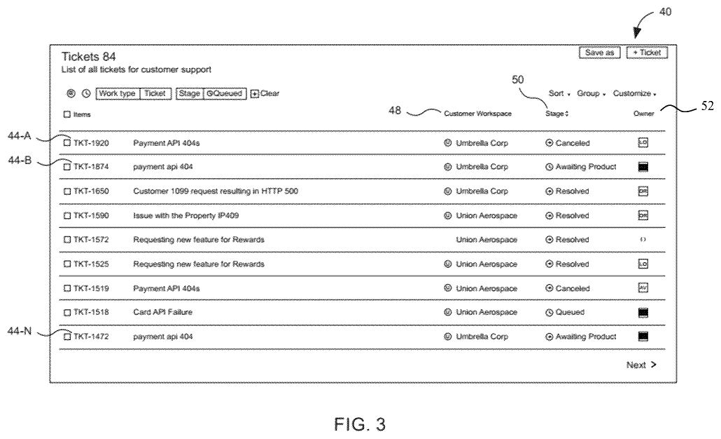

FIG. 2 is a flow chart describing one method by which clusters are generated asynchronously, implemented according to aspects of the present technique. The clusters are generated based on a recurring schedule that can be defined via a user interface. Each step of the process 22 is described in further detail below.

At step 24, a schedule is defined by a user to periodically access a plurality of work items. In one embodiment, the schedule are recurring intervals of time defined by a user. In one embodiment, the schedule include filters based on a time the work items were created or modified. Filters may also be based on an entity that was assigned to the work item, a status of the work item, etc. In one embodiment, the plurality of work items are tickets raised by customer service personnel in response to queries or reports raised by customers.

At step 26, the plurality of work items is retrieved based on the defined schedule. In one embodiment, the number of items retrieved at this stage, for example, could be all work items created in the past year. In another embodiment, they are only work items with stage set to open or in-progress. Further, a plurality of embeddings corresponding to the plurality of work items is also retrieved. In one embodiment, embeddings for the work items are generated using an embedding model that transforms a title and a description of a work item into a vector representation.

At step 28, a first hierarchy of clusters is generated by clustering embeddings corresponding to the defined schedule. Each cluster in the first hierarchy of clusters comprises a set of work items that correspond to the defined schedule. In one embodiment, a clustering model is used to generate the first hierarchy of clusters. Examples of clustering models used include variants of DBScan models or K-Mean models. In one embodiment, the clustering model is optimized to generate work groups with a maximum spread of work items across the work groups.

At step 30, further sets of clusters are iteratively generated based on the schedule. For example, a second hierarchy of clusters is generated by clustering embeddings corresponding to the schedule defined by the user. The second hierarchy of cluster comprises fewer number of work items than the first hierarchy of clusters. In a further embodiment, clusters are generated until a desired cluster size is reached. This allows for easy and fast processing of work items as the numbers are manageable. The generated clusters are then stored in a database and retrieved at a later point, as and when required.

In a further embodiment, a title is generated for each cluster based one or more recurring keywords in the work items. In a further embodiment, a summary for each work group is also generated. The summary includes a snapshot of the corresponding work group and may include details such as number of work items, a date range, etc. In one embodiment, the title and the summary are displayed to the users via the user interface. The user interface is interactive and enables the user to provide feedback about the work groups. The feedback for each work group is used to evaluate accuracy of the work group. Further, the feedback may also be provided to the clustering model for implementation while generating further work groups.

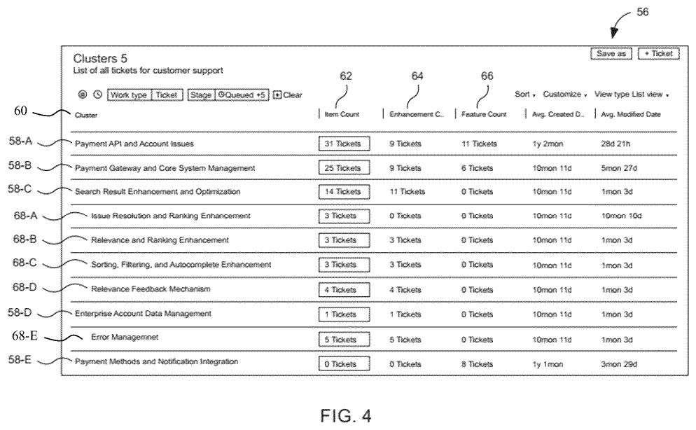

FIG. 3 is an example user interface that enables a user to view a plurality of work items at a given time. For the purpose of this example, the work items are referred to as tickets. User interface 40 displays to a user a list of tickets named generally 44-A, 44-B through 44-N. Each ticket includes further data such as a description 46-A and an origin workplace indicated by column 48. Status 50 provides a status of each ticket and owner 52 provides details about a owner of each ticket.

As can be seen, tickets 44-A through 44-N are in a random order and does not provide the user with details such as if the tickets are for a similar issue and does not show any relationship between individual tickets. However, once the clustering model is implemented the plurality of tickets are segregated into work groups as shown in

FIG. 4 is an example user interface that enables the user to view asynchronously generated clusters from the tickets 44-A through 44-N from FIG. 3. As can be seen in user interface 56, a set of five clusters have been asynchronously created indicated by reference numerals 58-A, 58-B through 58-E. It may also be noted that each cluster has a title 60 and an item count 62 to indicate a number of tickets in each cluster.

Enhancement count 64 and feature count 66 indicate to the user a number of work items that have already been assigned to enhancements or features, which form a more specific part category than products or capability. In one embodiment, if the enhancement count and the feature count of a cluster is similar to the work item count of the cluster, it indicates to the user the work items in the cluster have already been resolved. Further details regarding the number of days that the ticket has stayed open and an average time taken for an action to be completed is also provided.

Upon expansion of each cluster, for example cluster 58-C and 58-D, several sub-clusters are seen. For example, upon expansion of cluster 58-C, clusters 68-A through 68-E are seen. These represent the second hierarchy of clusters formed from the first hierarchy of cluster 58-C. In this specific example, the first cluster 58-C has 14 tickets while the second hierarchy of cluster 68-A through 68-C have three tickets each while cluster 68-D has four tickets and 68-E has just one ticket. Thus, 68-A through 68-E represent the second hierarchy of clusters where each cluster has a smaller number of tickets.

It may be noted from the above screenshots that the clustering system provides the user with many advantages including reducing the number of tickets in each cluster to a manageable number. The clustering system also summarize common topics from the set of work items and thus help users discover new bigger themes, or only inspect items related to a specific topic. The summary metrics allow users to inspect properties of the clusters and their underlying topics, such as the age of the cluster, or whether items have already been assigned to features or enhancements, that is if they are already handled.

The various actions, acts, blocks, steps, or the like as described above may be performed in the order presented, in a different order or simultaneously. Further, in some embodiments, some of the actions, acts, blocks, steps, or the like may be omitted, added, modified, skipped, or the like without departing from the scope of the invention.

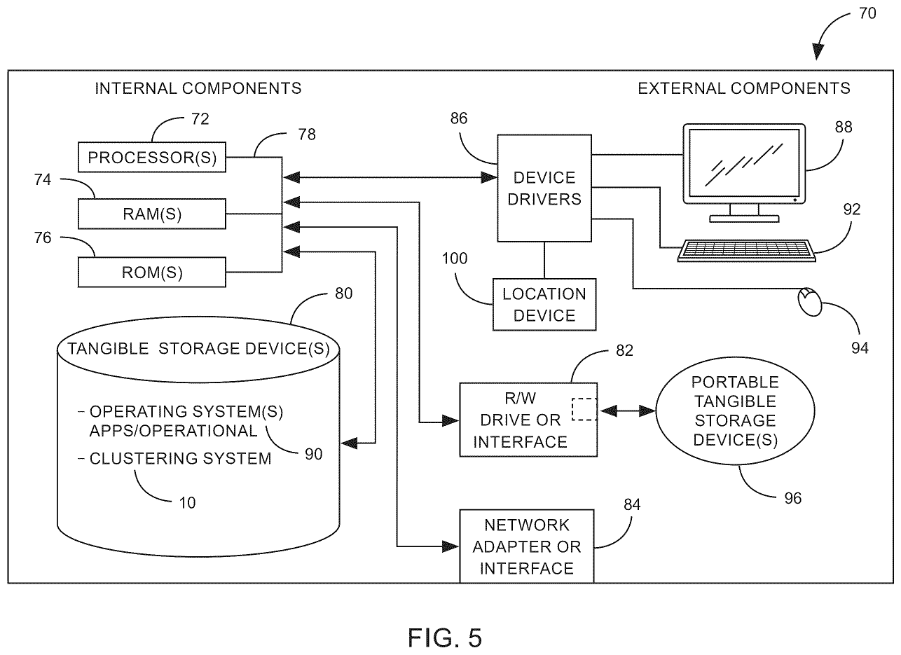

The asynchronous clustering system described herein is implemented using a computing device such as computing device 70 is described below in FIG. 5. The computing device 70 includes one or more processor(s) 72, one or more computer-readable RAMs 74 and one or more computer-readable ROMs 76 on one or more buses 78. Further, computing device 70 includes a tangible storage device 80 that may include clustering system 10 for clustering a plurality of work items. The various modules of the system 10 may be stored in the tangible storage device 80. Both, the operating systems 90 and the system 10 are executed by the one or more processor(s) 72 via one or more respective RAMs 74 (which typically include cache memory). The execution of the operating systems 90 and/or the system 10 by the one or more processor(s) configures the one or more processor(s) as a special purpose processor configured to carry out the functionalities of the operation systems) and/or the system 10 as described above.

Examples of the tangible storage device include semiconductor storage devices such as ROM, EPROM, flash memory or any other computer-readable tangible storage device that may store a computer program and digital information.

Computing device 70 also includes a R/W drive or interface 82 to read from and write to one or more portable computer-readable tangible storage devices 96 such as a CD-ROM, DVD, memory stick or semiconductor storage device. Further, network adapters or interfaces 84 such as a TCP/IP adapter cards, wireless Wi-Fi interface cards, or 3G or 4G wireless interface cards or other wired or wireless communication links are also included in computing device.

In one example embodiment, the system clustering 10 may be stored in the tangible storage device and may be downloaded from an external computer via a network (for example, the Internet, a local area network or other, wide area network) and network adapter or interface.

Computing device 70 further includes device drivers 86 to interface with input and output devices. The input and output devices may include a computer display monitor 88, a keyboard 92, a keypad, a touch screen, a computer mouse 94, and/or some other suitable input device.

In this description, including the definitions mentioned earlier, the term ‘module’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware. The term code, as used above, may include software, firmware, and/or microcode, and may refer to programs, routines, functions, classes, data structures, and/or objects.

Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above. Shared memory hardware encompasses a single memory device that stores some or all code from multiple modules. Group memory hardware encompasses a memory device that, in combination with other memory devices, stores some or all code from one or more modules.

In some embodiments, the module may include one or more interface circuits. In some examples, the interface circuits may include wired or wireless interfaces that are connected to a local area network (LAN), the Internet, a wide area network (WAN), or combinations thereof. The functionality of any given module of the present description may be distributed among multiple modules that are connected via interface circuits. For example, multiple modules may allow load balancing. In a further example, a server (also known as remote, or cloud) module may accomplish some functionality on behalf of a client module.

It will be understood by those within the art that, in general, terms used herein, are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present.

For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,”without other modifiers, means at least two recitations, or two or more recitations).

While only certain features of several embodiments have been illustrated, and described herein, many modifications and changes will occur to those skilled in the art. It is, therefore, to be understood that the appended claims are intended to cover all such modifications and changes as fall within the true spirit of inventive concepts.

The aforementioned description is merely illustrative in nature and is in no way intended to limit the disclosure, its application, or uses. The broad teachings of the disclosure may be implemented in a variety of forms. Therefore, while this disclosure includes particular examples, the true scope of the disclosure should not be so limited since other modifications will become apparent upon a study of the drawings, the specification. It should be understood that one or more steps within a method may be executed in different order (or concurrently) without altering the principles of the present disclosure. Further, although each of the example embodiments is described above as having certain features, any one or more of those features described with respect to any example embodiment of the disclosure may be implemented in and/or combined with features of any of the other embodiments, even if that combination is not explicitly described. In other words, the described example embodiments are not mutually exclusive, and permutations of one or more example embodiments with one another remain within the scope of this disclosure.

The example embodiment or each example embodiment should not be understood as a limiting/restrictive of inventive concepts. Rather, numerous variations and modifications are possible in the context of the present disclosure, in particular those variants and combinations which may be inferred by the person skilled in the art with regard to achieving the object for example by combination or modification of individual features or elements or method steps that are described in connection with the general or specific part of the description and/or the drawings, and, by way of combinable features, lead to a new subject matter or to new method steps or sequences of method steps, including insofar as they concern production, testing and operating methods. Further, elements and/or features of different example embodiments may be combined with each other and/or substituted for each other within the scope of this disclosure.

Still further, any one of the above-described and other example features of example embodiments may be embodied in the form of an apparatus, method, system, computer program, tangible computer readable medium and tangible computer program product. For example, of the aforementioned methods may be embodied in the form of a system or device, including, but not limited to, any of the structure for performing the methodology illustrated in the drawings.

In this application, including the definitions below, the term ‘module’ or the term ‘controller’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

Further, at least one example embodiment relates to a non-transitory computer-readable storage medium comprising electronically readable control information (e.g., computer-readable instructions) stored thereon, configured such that when the storage medium is used in a controller of a magnetic resonance device, at least one example embodiment of the method is carried out.

Even further, any of the aforementioned methods may be embodied in the form of a program. The program may be stored on a non-transitory computer readable medium, such that when run on a computer device (e.g., a processor), cause the computer-device to perform any one of the aforementioned methods. Thus, the non-transitory, tangible computer readable medium is adapted to store information and is adapted to interact with a data processing facility or computer device to execute the program of any of the above-mentioned embodiments and/or to perform the method of any of the above-mentioned embodiments.

The computer readable medium or storage medium may be a built-in medium installed inside a computer device main body or a removable medium arranged so that it may be separated from the computer device main body. The term computer-readable medium, as used herein, does not encompass transitory electrical or electromagnetic signals propagating through a medium (such as on a carrier wave), the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices), volatile memory devices (including, for example static random access memory devices or a dynamic random access memory devices), magnetic storage media (including, for example an analog or digital magnetic tape or a hard disk drive), and optical storage media (including, for example a CD, a DVD, or a Blu-ray Disc). Examples of the media with a built-in rewriteable non-volatile memory, include but are not limited to memory cards, and media with a built-in ROM, including but not limited to ROM cassettes, etc. Furthermore, various information regarding stored images, for example, property information, may be stored in any other form, or it may be provided in other ways.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave), the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices), volatile memory devices (including, for example static random access memory devices or a dynamic random access memory devices), magnetic storage media (including, for example an analog or digital magnetic tape or a hard disk drive), and optical storage media (including, for example a CD, a DVD, or a Blu-ray Disc). Examples of the media with a built-in rewriteable non-volatile memory, include but are not limited to memory cards, and media with a built-in ROM, including but not limited to ROM cassettes, etc. Furthermore, various information regarding stored images, for example, property information, may be stored in any other form, or it may be provided in other ways.

The apparatuses and methods described in this application may be partially or fully implemented by a special purpose computer created by configuring a general-purpose computer to execute one or more particular functions embodied in computer programs. The functional blocks and flowchart elements described above serve as software specifications, which may be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C #, Objective-C, Haskell, Go, SQL, R, Lisp, Java®, Fortran, Perl, Pascal, Curl, OCaml, Javascript®, HTML5, Ada, ASP (active server pages), PHP, Scala, Eiffel, Smalltalk, Erlang, Ruby, Flash®, Visual Basic®, Lua, and Python®.

1. A clustering system for clustering work items, the clustering system comprising:
a user interface configured to enable a user to define a schedule, the user interface generated for the clustering system comprising a computing device having one or more processors;
a clustering module communicatively coupled to the user interface and configured to: retrieve a plurality of work items from a work database based on the schedule; retrieve a plurality of embeddings corresponding to the plurality of work items; generate a first hierarchy of clusters by clustering embeddings based on the defined schedule.

2. The clustering system of claim 1, wherein the clustering module is further configured to generate a second hierarchy of clusters from each cluster in the first hierarchy of clusters, wherein the number of work items in the second hierarchy of clusters is less than the number of work items in the first hierarchy of clusters.

3. The clustering system of claim 2; wherein the second hierarchy of clusters are generated based on one or more the schedule.

4. The clustering system of claim 2, wherein the clustering module is further configured to iteratively generate a subsequent hierarchy of clusters, wherein the number of work items in each subsequent hierarchy of clusters is less than the number of work items in a preceding hierarchy of clusters.

5. The clustering system of claim 1, wherein the schedule is recurring at regular intervals of time and is defined by the user.

6. The clustering system of claim 4, further comprising a database configured to store the first hierarchy of clusters, the second hierarchy of clusters and the subsequent hierarchy of clusters.

7. The clustering system of claim 4, wherein the database is configured to delete the first hierarchy of clusters, the second hierarchy of clusters and the subsequent hierarchy of clusters upon completion of a subsequent schedule.

8. The clustering system of claim 1, wherein the clustering module is further configured to generate a title for each hierarchical cluster.

9. The clustering system of claim 7, wherein each hierarchical cluster and the corresponding title is displayed to the one or more users via the user interface.

10. The clustering system of claim 1, wherein the user interface is configured to display, for each schedule, a snapshot of the first hierarchy of clusters, the second hierarchy of clusters and the subsequent hierarchy of clusters.

11. A method for clustering a plurality of work items, the method comprising:
defining a schedule on a user interface configured to enable a user to define the schedule, the user interface generated for a clustering system comprising a computing device having one or more processors;
retrieving a plurality of work items from a work database based on a recurring schedule;
retrieving a plurality of embeddings corresponding to the plurality of work items; and
generating a first hierarchy of clusters by clustering embeddings based on the defined schedule.

12. The method of claim 11, further comprising generating a second hierarchy of clusters from each cluster in the first hierarchy of clusters, wherein the number of work items in the second hierarchy of clusters is less than the number of work items in the first hierarchy of clusters.

13. The method of claim 12, further comprising iteratively generating a subsequent hierarchy of clusters, wherein the number of work items in each subsequent hierarchy of clusters is less than the number of work items in a preceding hierarchy of clusters.

14. The method of claim 13, further comprising storing the first hierarchy of clusters, the second hierarchy of clusters and the subsequent hierarchy of clusters.

15. The method of claim 13, further comprising deleting the first hierarchy of clusters, the second hierarchy of clusters and the subsequent hierarchy of clusters upon completion of the schedule.

16. The method of claim 11, further comprising generating a title for each hierarchical cluster.

17. The method of claim 16, further comprising generating a summary for each hierarchical cluster.

18. The method of claim 16, further comprising displaying each hierarchical cluster and the corresponding work group title to the one or more users via the user interface.

19. The method of claim 18, further comprising displaying, for each schedule, a snapshot of the first hierarchy of clusters, the second hierarchy of clusters and the subsequent hierarchy of clusters.

20. The method of claim 11, wherein the schedule is recurring at regular intervals of time and is defined by the user.
